(19) United States
(12) Patent Application Publication
(10) Pub. No.: US 2014/0050147 A1
(43) Pub. Date: Feb. 20, 2014

(54) WIRELESS COMMUNICATIONS SYSTEMS

(71) Applicant: Martin Beale, Bristol (GB)

(72) Inventor: Martin Beale, Bristol (GB)

(73) Assignee: NVIDIA CORPORATION, Santa Clara, CA (US)

(21) Appl. No.: 13/879,614

(22) PCT Filed: Oct. 12, 2011
(86) PCT No.: PCT/GB2011/051967

§ 371 Date: May 22, 2013

(30) Foreign Application Priority Data
Oct. 13, 2010 (GB) 1017239.3

(51) Int. Cl. H04W 4/00

(52) U.S. Cl. CPC H04W 4/005
USPC 370/328

(57) ABSTRACT

A method of controlling data transmission over a radio network between a first machine-type communication (MTC) entity and a second MTC entity in a wireless telecommunications system is described. The method comprises an element of the radio network architecture, for example a base station, deriving a transmission cost for transmitting data between the first and second MTC entities based on traffic load, and then communicating the transmission cost to one or both of the MTC entities. The MTC entities may then control their data transmissions based on the transmission cost. Thus the radio network is able to dynamically manage traffic load by providing a cost incentive for transmitting MTC data when network resources are under utilised and applying a cost penalty for transmissions made while the network is relatively busy. Furthermore, the MTC entities of the wireless communication system are able to select times and/or manner of data transmissions to reduce their overall cost of using the network.

### BACKGROUND ART

The present invention relates wireless communication systems and in particular to methods and apparatus for controlling data transmission in wireless communication systems.

Mobile communication systems have evolved over the past ten years or so from the GSM System (Global System for Mobile communications) to the 3G system and now include packet data communications as well as circuit switched communications. The third generation partnership project (3GPP) has now begun to develop a mobile communication system referred to as Long Term Evolution (LTE) in which a core network part has been evolved to form a more simplified architecture based on a merging of components of earlier mobile radio network architectures and a radio access interface which is based on Orthogonal Frequency Division Multiplexing (OFDM) on the downlink and Single Carrier Frequency Division Multiple Access (SC-TDMA) on the uplink.

At present mobile communications services are dominated by human to human (H2H) communications, that is, data transmissions which are instigated by a human. It is now recognised that there is a desire to cater for communications to and/or from machines which are referred to generally as machine type communications (MTC) or machine to machine (M2M) communications. Thus in some respects, H2H communications may be broadly considered as being communications which are initiated in response to human interaction or input, whereas MTC/M2M communications may in some respects be broadly considered as being communications which are autonomously or semi-autonomously initiated by a machine (that it to say any non-human device). MTC communications may therefore in some respects be seen as communications in which a machine triggers a request for network resources for the purpose of data transfer.

Thus MTC communications may be characterised as communicating data which has been triggered automatically, for example in response to some other stimulus or event or reporting some attribute of a machine or some monitored parameter, for example in so-called smart metering. Thus whilst human communications such as voice can in some respects be characterised as being communications requiring a communications session of some minutes with data being generated in bursts of several milliseconds with pauses there between, or video which can be characterised as streaming data at a substantially constant bit rate, MTC communications can in some respects be characterised as sporadically communicating small quantities of data. It will, however, be appreciated there is also a wide variety of other possible MTC communication characteristics. For example, another characteristic of MTC communications is the time at which data is transmitted is often less significant than for M2H communications. That is to say, MTC communications, or at least certain types of MTC communications, are what might be referred to as delay tolerant. For example, in a smart metering implementation in which a remote MTC terminal is required to transmit usage data to a central MTC server, the exact time at which the usage data is transmitted from the MTC terminal to the MTC server is often not critical. Thus one defining characteristic of some types of MTC communication is that the timing of the communication is not so critical as for other types of communication, for example H2H communications. For example, with an MTC type communication there will often be no problems arising if the communication is not made until some time after the data is ready for transfer.

As will be appreciated, it is generally desirable in wireless communication systems to use the available radio communications bandwidth and core network resources as efficiently as possible. However, the increasing use of MTC communications in these systems gives rise to new challenges in this area.

### SUMMARY OF THE INVENTION

According to a first aspect of the invention there is provided a method of controlling data transmission over a radio network between a first machine-type communication (MTC) entity and a second MTC entity in a wireless telecommunications system, the method comprising: the radio network determining a transmission cost parameter representing a cost associated with transmitting data between the first and second MTC entities and communicating the transmission cost parameter to the first MTC entity, and the first MTC entity controlling data transmission between the first and second MTC entities in dependence on the transmission cost parameter.

Thus in accordance with embodiments of the invention, the radio network is able to dynamically manage traffic load by providing a cost incentive for transmitting MTC data when the network's resources are under utilised and in effect applying a cost penalty for MTC data transmissions made while the network is busy. This furthermore means the MTC entities of the wireless communication system are able to select times and/or manner of their data transmissions to reduce their overall cost for using the network.

The MTC entities may, for example, correspond to an MTC terminal and an MTC server whereby the MTC terminal is arranged to report data back to the MTC server or receive data from the MTC server. More generally, an MTC entity may be any device that employs MTC-type communications to communicate data, for example on behalf of what might be termed an MTC operator. For example, an MTC operator may be a utilities company which has deployed a number of MTC terminals at customers' premises in association with utility meters, whereby the MTC terminals are operable to communicate data from their respective meters through the radio network to an MTC server. The MTC server may thus be responsible for obtaining, storing and acting on data received from the MTC terminals in accordance with the requirements of the MTC operator. In general, the specific nature of the MTC entities, the reason for their deployment by the MTC operator and the function they perform is not significant to the operation of embodiments of the invention.

The transmission cost parameter may be determined in dependence on a level of radio network traffic. For example, in dependence on an average level of traffic passing through the radio network (or part of the network to which the transmission cost parameter applies) in a preceding period. Transmission cost parameters may be determined and communicated according to various schedules. For example, the radio network may be configured to periodically communicate an updated transmission cost parameter, for example at regular intervals or when a change in transmission cost parameter is desired. Alternatively, the transmission cost parameter might be communicated to individual MTC entities on request.

The step of the MTC entity controlling data transmission may comprise the MTC entity determining whether or not to transmit the data. If the MTC entity decides not to transmit data in view of the cost, the data may be stored for later transmission, for example when the transmission cost falls or it becomes more important to transmit the data without further delay. In some example embodiments, the MTC entity may simply discard data that is not transmitted.

In some implementations of an embodiment of the invention the step of the MTC entity controlling data transmission may comprise the MTC entity selecting particular transmission characteristics for the data according to the transmission cost (as opposed to making a binary transmit/do not transmit decision). For example, an MTC entity arranged to stream a video signal might choose to do so at lower quality (lower data rate) when transmission costs are high.

In so far as the radio network implemented features are concerned, these may be performed at different levels in the network architecture according to the desired granularity of transmission control. For example, the step of determining the transmission cost parameter may be performed in a transceiver station (base station/e-nodeB) of the radio network such that the transmission cost parameter is specific to data transmissions through that particular transceiver station. Different transceiver stations in the radio network may thus each set their own transmission cost parameter so that transmission control occurs on a per transceiver station basis. In other examples larger scale control may be implemented, for example with a network element setting a transmission cost parameter applying to multiple transceiver stations. Thus transmission control may be centrally controlled on a geographic scale larger than individual cells of the network.

In addition to MTC entities controlling data transmission in dependence on a variable transmission cost parameter, the step of the MTC entity controlling data transmission may also depend on a transmission priority level for the data. Thus, for a given transmission cost parameter data considered high priority, for example an alarm signal, may be transmitted while data of a lower priority, for example one of many regular stock updates for a vending machine, may not be transmitted. In some cases the priority level for data may change with time. For example, even a relatively mundane stock update might be escalated to a high priority if it is not transmitted within what is considered to be an acceptable time frame. The setting of priority levels will depend on the specific application at hand and the functionality supported by the MTC entities.

In some example embodiments the transmission cost parameter may be associated with data transmission using a first transmission path in the radio network and the method may further comprise determining another transmission cost parameter representing a cost associated with transmitting data using a second transmission path which is different from the first transmission path. For example, different transmission costs may be associated with different transmission paths associated with different transceiver stations in the network. In such cases the step of communicating the transmission cost parameter to the first MTC entity may comprise collating transmission cost parameters associated with different transmission paths together and communicating the collated transmission cost parameters together to the first MTC entity.

The method may further comprise a step of establishing which transmission path would be used in transmitting data to the second MTC entity, for example based on which transceiver station the second MTC entity is coupled to, and communicating the corresponding transmission cost to the first MTC entity with an indication that it is associated with data transmission to the second MTC entity.

According to another aspect of the invention there is provided a method of controlling data transmission associated with a machine-type communication (MTC) entity over a radio network in a wireless telecommunications system, the method comprising: the radio network determining a transmission cost parameter representing a cost associated with transmitting data in the radio network and communicating the transmission cost parameter to the MTC entity; and the MTC entity controlling data transmission associated with the MTC entity in dependence on the transmission cost parameter.

According to another aspect of the invention there is provided a method for establishing costs for transmitting data associated with a machine-type communication (MTC) entity over a radio network in a wireless telecommunications system, the method comprising: determining a transmission cost parameter representing a cost associated with transmitting data in the radio network; and communicating the transmission cost parameter to the MTC entity.

According to another aspect of the invention there is provided a method for controlling data transmission from a machine-type communication (MTC) entity over a radio network in a wireless telecommunications system, the method comprising: receiving from the radio network a transmission cost parameter representing a cost associated with transmitting data over the radio network; and controlling data transmission from the MTC entity in dependence on the transmission cost parameter.

According to another aspect of the invention there is provided a wireless telecommunications system comprising a radio network and first and second machine-type communication (MTC) entities arranged to communicate data between themselves over the radio network; wherein the radio network comprises a transmission cost generator unit and a transmission cost communication unit, wherein the transmission cost generator unit is operable to determine a transmission cost parameter representing a cost associated with transmitting data over the radio network and the transmission cost communication unit is operable to communicate the transmission cost parameter from the radio network to the first MTC entity; and the first MTC entity comprises a data transmission controller unit operable to control data transmission between the first and second MTC entities in dependence on the transmission cost parameter.

According to another aspect of the invention there is provided a wireless telecommunications system comprising a radio network and a machine-type communication (MTC) entity arranged to communicate data over the radio network; wherein the radio network comprises a transmission cost generator unit and a transmission cost communication unit, wherein the transmission cost generator unit is operable to determine a transmission cost parameter representing a cost associated with transmitting data over the radio network and the transmission cost communication unit is operable to communicate the transmission cost parameter from the radio network to the MTC entity; and the MTC entity comprises a data transmission controller unit operable to control data transmission associated with the MTC entity in dependence on the transmission cost parameter.

According to another aspect of the invention there is provided a radio network infrastructure element for use in a radio network, the radio network infrastructure element comprising: a transmission cost generator unit operable to determine a transmission cost parameter representing a cost associated with transmitting data over the radio network between machine-type communication (MTC) entities; and a transmission cost communication unit operable to communicate the transmission cost parameter to at least one MTC entity.

According to another aspect of the invention there is provided a machine-type communication entity comprising: a transmission cost receiving unit operable to receive from a radio network a transmission cost parameter representing a cost associated with transmitting data over the radio network; and a data transmission controller unit operable to control data transmission over the radio network in dependence on the received transmission cost parameter.

According to another aspect of the invention there is provided a wireless telecommunications system comprising a radio network and first and second machine-type communication (MTC) entities arranged to communicate data between themselves over the radio network; wherein the radio network comprises means for determining a transmission cost parameter representing a cost associated with transmitting data over the radio network and means for communicating the transmission cost parameter from the radio network to the first MTC entity; and the first MTC entity comprises means for controlling data transmission between the first and second MTC entities in dependence on the transmission cost parameter.

According to another aspect of the invention there is provided a radio network infrastructure element comprising: means for determining a transmission cost parameter representing a cost associated with transmitting data over the radio network between in chine-type communication (MTC) entities; and means for communicating the transmission cost parameter to at least one MTC entity.

According to another aspect of the invention there is provided a machine-type communication entity comprising: means for receiving from a radio network a transmission cost parameter representing a cost associated with transmitting data over the radio network; and means for controlling data transmission over the radio network in dependence on the received transmission cost parameter.

It will be appreciated that features of the above-described aspects and embodiments of the invention may be combined with features of other aspects and embodiments of the invention as appropriate and in combinations other than those explicitly set out. For example, optional features of the first aspect of the invention may equally optionally be incorporated in embodiments according to other aspects of the invention, for example where the different aspects have corresponding features.

### BRIEF DESCRIPTION OF THE DRAWINGS

Example embodiments of the present invention will now be described with reference to the accompanying drawings in which like parts have the same designated references and in which:

FIG. 1 is a schematic block diagram of a radio network and a plurality of user equipments forming a wireless communication system which operates in accordance with the 3GPP Long Term Evolution (LTE) standard;

FIG. 2 schematically shows the wireless communications system of FIG. 1 in simplified form in a machine-type communication context;

FIG. 3 schematically shows a wireless communications system according to an embodiment of the invention;

FIG. 4 is a processing flow diagram schematically showing steps performed in the radio network of the wireless communications system of FIG. 3 in accordance with an embodiment of the invention;

FIG. 5 is a graph schematically showing an example variation in transmission cost with time determined in accordance with an embodiment of the invention; and

FIG. 6 is a processing flow diagram schematically showing further steps performed in a machine-type communication entity in the wireless communications system of FIG. 3 in accordance with an embodiment of the invention.

### DETAILED DESCRIPTION

Embodiments of the present invention will be described with particular reference to an implementation in a wireless communication system which uses a mobile radio network operating in accordance with the 3GPP Long Term Evolution (LTE) standard. It will, however, be appreciated that embodiments of the invention may also be implemented in wireless telecommunication systems based on a radio network conforming to any other of the various well-know standards, for example, GSM, 3G/UMTS, CDMA2000, etc.

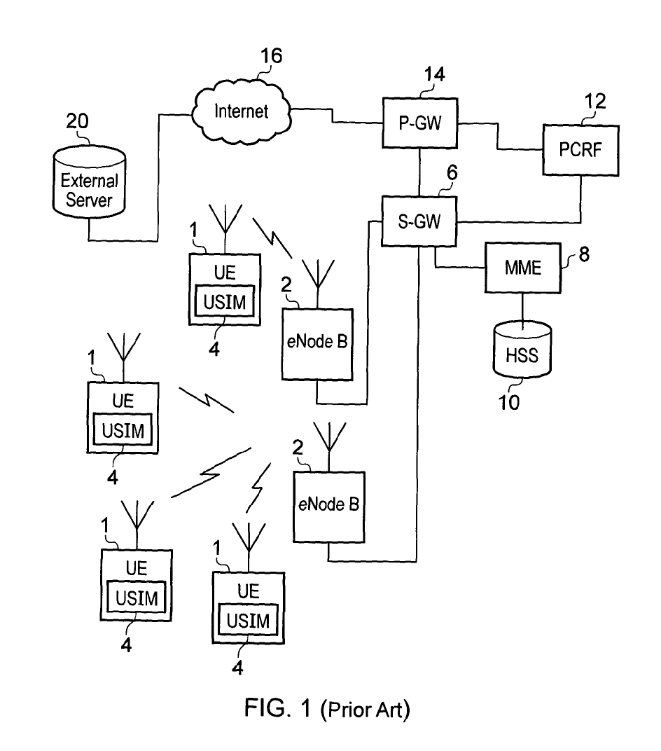

FIG. 1 schematically shows an example architecture of an LTE system. The LTE system is provided by a telecommunications network operator to allow parties to communicate. In many cases the network operator may be wholly responsible for providing the LTE system in the sense of being responsible for managing the equipment comprising the LTE system. In other cases, the network operator may not be responsible for managing the equipment comprising the LTE system, but may instead lease the right to use the resources of an LTE system belonging to another telecommunications network operator. In this case the network operator might be referred to as a virtual network operator. For the purposes of this description it will be appreciated that it is not significant whether or not a network operator implementing an embodiment of the invention is a conventional network operator or a virtual network operator.

As shown in FIG. 1, and as with a conventional mobile radio network, mobile communications devices designated as user equipment (UE) 1 are arranged to communicate data to and from base stations (transceiver stations) 2 which are frequently referred to in LTE as enhanced NodeBs (e-nodeB). As shown in FIG. 1, each of the mobile communications devices 1 includes a Universal Subscriber Identity Module (USIM) 4 which includes information and parameters which allow the mobile communications devices to access the mobile radio network and to be authenticated for services to which the users have subscribed.

The e-nodeBs 2 are connected to a serving gateway S-GW 6 which is arranged to perform routing and management of mobile communications services to the communications devices 1 in the mobile radio network. In order to maintain mobility management and connectivity, a mobility management entity (MME) 8 manages the enhanced packet service (EPS) connections with the communications devices 1 using subscriber information stored in a home subscriber server (HSS) 10. Other core network components include the policy charging and resource function (PCRF) 12 a packet data gateway (P-GW) 14 which connects to an internet network 16 and finally to a external server 20. In the context of MTC communications a UE supporting MTC communications may, for example, be conveniently referred to as an MTC terminal or MTC UE, and a server with which the MTC terminal(s) communicate data may, for example, be conveniently referred to as an MTC server. More generally, devices in the system capable of supporting MTC communications may be referred to as MTC entities.

The various elements of FIG. 1 and their respective modes of operation are well-known and defined in the relevant standards administered by the 3GPP (RTM) body and also described in many books on the subject, for example, Holma H. and Toskala A [1]. These conventional aspects of LTE networks are not described further in the interest of brevity.

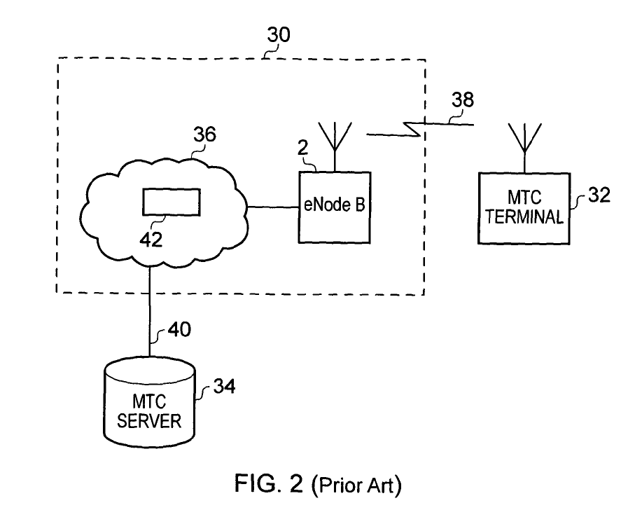

FIG. 2 schematically represents the conventional LTE wireless communication system of FIG. 1 in simplified form in the context of communicating data between MTC entities/elements. The system may be considered to comprise a radio network 30, an MTC terminal 32 (for example corresponding to one of the UEs of FIG. 1) and an MTC server 34, The MTC terminal 32 and MTC server 34 are arranged to communicate data between themselves in accordance with their particular functionality. MTC communications and H2H communications in the radio network may, for example, be made on the same carrier.

The radio network 30 is schematically shown in FIG. 2 as comprising an e-nodeB 2 with the other radio network elements schematically shown as a single functional unit which, for convenience, may be referred to here as the backhaul network 36. For example, and with reference to FIG. 1, the backhaul network 36 of FIG. 2 comprises the S-GW 6, MME 8, HSS 10 and so forth. Although not shown for simplicity, the radio network 30 comprises multiple e-nodeBs operating in the same manner. The MTC terminal 32 is communicatively connectable to the radio network over a radio interface 38 in a conventional a manner and the MTC server 34 is communicatively connectable to the radio network via, for example, an internet-based interface 40. Thus the MTC terminal 32 and MTC server 34 are operable to communicate data via the radio network 30.

A billing controller unit 42 is associated with the radio network and is responsible for generating invoicing information for users of the radio network based on their usage. Conventionally an operator of the MTC terminal and MTC server, for example a utilities company, will be charged based on the amount of data transferred through the radio network and/or an amount of time taken to transfer the data according to a pre-agreed tariff. For example the MTC operator, that is to say the party responsible for the MTC terminal and server, for example, a utilities company, might be charged X per kilobyte of data, or Y per minute they connect through the radio network.

One issue associated with the increased use of MTC entities in wireless communications networks is the potential for MTC communications to impact the ability of the radio network to support a high quality of service for H2H communication. This is because finite resources available within the network, for example radio bandwidth, might readily become consumed by large numbers of MTC terminals seeking to communicate data back to an MTC server. For example, in the context of smart metering there may be several hundred utility meters within a cell associated with a base station which all try to connect around the same time to send utility consumption information for a preceding period. The large number of MTC radio connections/connection requests may then reduce the ability of the radio network to support H2H communications at this time. This represents a sub-optimal use of the available network resources in that the disruption to H2H communications may significantly affect an H2H user who wants to use the network at that time, whereas in many cases it would not matter to any significant degree if the MTC communications were made at some other time, for example if the MTC communications were more spread out in time or made during periods when the network was otherwise not so busy.

To help address this issue the Inventor has recognized that a dynamic charging scheme may be adopted for MTC communications in wireless communications systems and this may be used to play a role in better controlling data transmissions between MTC entities. Thus in accordance with some embodiments of the invention, a radio network may periodically communicate to MTC terminals and/or MTC servers a parameter indicating a cost for transmitting data through the radio network. In some examples the cost may be referred to as a “current” cost in as much as it may be considered a cost that is to be taken as valid until a different cost parameter is sent out. Thus for the purposes of this description the term “current transmission cost parameter” may be used to refer to this cost parameter. It will be appreciated, however, that this does not mean the term should necessarily be interpreted as meaning the cost parameter refers to transmissions made at the current time, although in some cases it might. However, in other cases the transmission cost parameter may, for example, be communicated to MTC entities in advance of the time it becomes “valid”. Thus the transmission cost parameter may be seen as providing an indication to MTC entities of charges may be expected for data transmissions made at whatever time the transmission cost parameter is valid, which will depend on the specific implementation at hand. In this regard the transmission cost parameter may also be referred to as an expected transmission cost parameter.

The transmission cost may be varied by individual base stations for the respective cells they are serving. For example, a base station supporting a cell experiencing a high H2H communication load might increase the effective cost of MTC communications during the period the H2H communication load remains high to discourage the MTC entities from communicating through the base station while the H2H traffic remains high. Conversely, a neighbouring base station experiencing a relatively low H2H communication load may communicate a low current transmission cost to the MTC entities to encourage them to make data transmissions while the radio traffic passing through that base station is currently low.

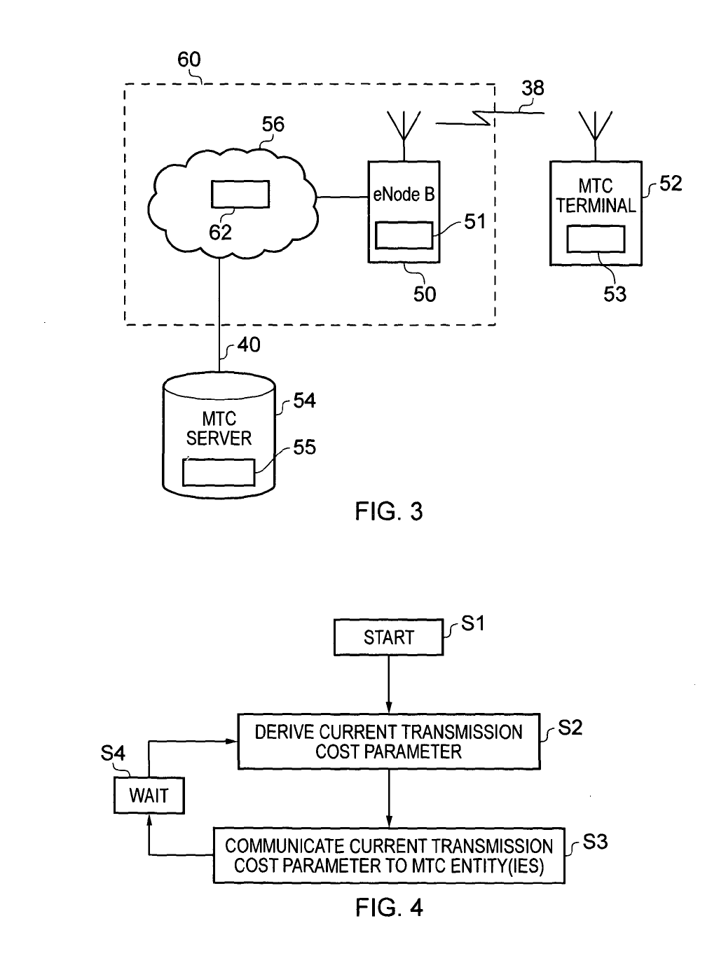

FIG. 3 schematically represents a simplified LTE wireless communication system according to an embodiment of the invention. The system is represented as comprising a radio network 60, an MTC terminal 52 and an MTC server 54. The MTC terminal 52 and MTC server 54 may be collectively referred to as MTC entities 52, 54 and are arranged to communicate data between themselves in accordance with their particular functionality. For the sake of a concrete example, it will be assumed here that the MTC terminal 52 is coupled to a vending machine (not shown) and the MTC server 54 implemented in a computer at the vending company's headquarters which is configured to manage the operation and refilling of the vending machine. For example, the MTC terminal 52 may be arranged to transmit a weekly stock level report to the MTC server 54 and the MTC server 54 may periodically send operational updates to the MTC terminal 52, for example price changes. It will of course be appreciated that the exact nature of the MTC terminal and MTC server and the data to be transmitted between them is not significant to the operation of embodiments of the invention.

In a broadly similar manner to FIG. 2, the radio network 60 of FIG. 3 is schematically shown as comprising an e-nodeB 50 with other radio network elements schematically shown as a single functional unit which, again for convenience, may be referred as the backhaul network 56. In practice there will be multiple e-nodeBs operating in the network, but only one is shown in FIG. 3 for simplicity. The different e-nodeBs of the network may all operate in broadly the same manner. It will be appreciated that apart from as discussed herein in relation to the implementation of embodiments of the invention, other operational aspects of the wireless communication system of FIG. 3 may be conventional.

The wireless communication system of FIG. 3 differs from a conventional wireless communication system in that the e-NodeB 50 includes a transmission cost generator unit 51 and the MTC server and MTC terminal include respective data transmission controller units 55, 53. The backhaul network also includes a modified billing controller unit 62 which is adapted to operate in conjunction with the other system elements as discussed further below. As is conventional for an LTE wireless communication system, the billing controller unit 62 is logically located in a Non Access Stratum (NAS) entity.

The transmission cost generator unit 51 in the e-nodeB, the data transmission controller units 55, 53 in the respective MTC entities and the modified billing controller unit 62 are schematically represented in FIG. 3 as discrete functional units for ease of representation only. It will be appreciated in many practical implementations the functionality provided by these units will be provided as an integral part of the overall functionality of the respective network elements with which they are associated, for example, through appropriate programming of their control algorithms.

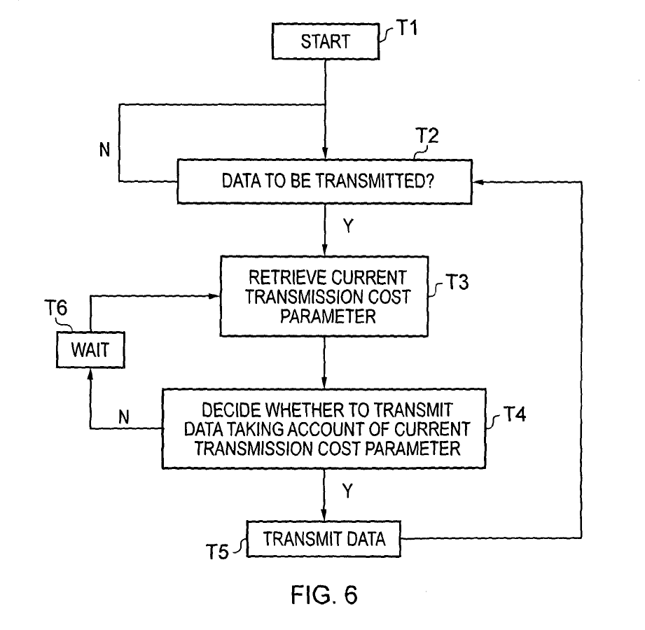

An example of the operation of the wireless communication network of FIG. 3 in accordance with an embodiment of the invention will now be described with reference to the schematic processing flow diagrams of FIGS. 4 and 6.

FIG. 4 schematically shows processing steps performed by the transmission cost generator unit 51 in the e-nodeB 50 to derive and communicate a current cost parameter to MTC entities which may want to transmit data through the e-nodeB.

Processing starts in Step S1, for example after an initial switch-on/reset of the e-nodeB.

In Step S2 the cost generator unit 51 derives a current transmission cost parameter. The current transmission cost parameter may take various forms in different example implementations. In some examples the current transmission cost parameter may be a literal monetary cost, for example characterised as a specific monetary cost per kilobyte of data transmitted or per minute of connection time. In other examples the current transmission cost parameter may be a scaling factor to apply to whatever base cost for transmitting data has been agreed between the network operator and MTC entity operators. This will allow the network operator to implement an embodiment of the invention while maintaining a differential charging structure for different uses. In other examples the transmission cost parameter might not represent a monetary cost for transmitting data but might represent an abstract cost to MTC users of the network. For example, the current transmission cast parameter might reflect a percentage chance of a data transmission failing because the network is busy. MTC entities may then decide to delay transmitting data until the percentage chance of failure is low so as to avoid the internal operational cost of having to make multiple transmission re-attempts. In this example it will be assumed the current transmission cost parameter is a monetary cost per kilobyte to be transmitted.

The current transmission cost parameter may be derived by the e-nodeB in Step S2 according to the extent to which there is a desire to encourage or discourage additional usage of the e-NodeB's resources at that time. In this example it is assumed the current transmission cost parameter is based solely on the present average traffic loading experienced by the e-nodeB, for example averaged over a preceding period of 5 or 10 minutes.

If the present traffic loading is about average, the e-NodeB may select a current transmission cost parameter corresponding to what might be considered a base level cost per kilobyte of data. The exact monetary cost in a particular implementation will depend on the radio network operator's overall charging strategy. However, the base level cost might correspond to what the network operator might expect to charge if they were operating a fixed cost scheme and not implementing a dynamically changing cost in accordance with an embodiment of the invention.

When the radio traffic loading on the e-nodeB is not about average, the current transmission cost parameter may be varied in a broadly proportional manner with respect to the traffic loading. The most appropriate functional dependence in a given implementation may be based on modelling user behaviour to achieve a desired user response. In general the most appropriate relationship between network traffic loading and current transmission cost parameter will be difficult to predict accurately because the extent to which the dynamic changing cost will moderate MTC usage will depend on the extent and for how long the connected MTC entities are willing to delay transmission of data as well as the individual attitudes of the MTC operators to costs. Accordingly, the functional dependence and extreme values for the current transmission cost parameter may be based on observed behaviour during a testing/roll out phase. For example, an initial relationship between e-nodeB traffic loading and current transmission cost parameter may be deployed and MTC use monitored accordingly, e.g. for a few days or weeks. If this trial period shows there is little reduction in MTC traffic when the current transmission cost parameter is increased, the network operator may decide to increase the rate at which the current transmission cost parameter increases with traffic loading until the desired reduction in MTC communications during heavy H2H loading is achieved.

In Step S3 the current transmission cost parameter derived by the e-nodeB for the current traffic conditions is communicated to any MTC entities that may wish to transmit data through the e-nodeB. Typically this will be any registered MTC terminals in the cell the e-nodeB is supporting and any MTC servers that may wish to communicate with the MTC terminals in the e-nodeB's cell. The e-nodeB may be considered to functionally comprise a transmission cost communication unit for communicating the current transmission cost parameter. The transmission cost communication unit may be configured so that the current transmission cost parameter is communicated to the relevant MTC terminal(s) over conventional control channels, for example, a broadcast or BCH channel. The parameter may also be communicated back to the relevant MTC server(s) using appropriate signalling. For example, in the case schematically represented in FIG. 3 in which the MTC server 54 is coupled to the radio network by an internet interface 40, the parameter may be communicated via a gateway in the radio network arranged to translate between signalling within the radio network to internet signalling. In principle each individual e-nodeB might communicate its respective current transmission cost parameters back to the respective MT servers. However, in a given communication system there may be many e-NodeBs and many MTC servers and so in some examples a collation function is provided by a cost parameter collation unit in the radio network that is responsible for receiving individual current transmission cost parameters from different e-nodeBs and distributing these as a single table to the MTC servers. In some embodiments the relevant current transmission cost parameters may be provided to the MTC servers as a cost for transmitting to specific MTC devices as opposed to a cost for using specific e-NodeBs. For example, the cost of transmitting through a particular e-NodeB might be established as X in accordance with an embodiment of the invention. The radio network may generate a list of MTC devices being served by this particular e-NodeB and provide this to the MTC server with an indication of the cost parameter X associated with communications with the MTC devices on the list. Thus, there is no need for the MTC itself to track which MTC terminals are associated with which e-nodeBs.

The respective MTC entities to which the transmission cost data is communicated may be considered to functionally comprise a transmission cost receiving unit for receiving the current transmission cost parameter from the radio network. The transmission cost receiving unit may be configured so that the current transmission cost parameter is received by the relevant MTC terminal(s) over conventional control channels, such as broadcast or BCH channels. The respective MTC entities may then store the current transmission cost parameter(s) for the e-nodeBs they may wish to use.

Once the e-nodeB has instigated the communication of its current transmission cost parameter to the relevant MTC entities processing proceeds to Step S4. In Step S4 the processing is paused for a wait period before processing returns to Step S2 for the next transmission cost parameter to be determined (that it to say the transmission cost parameter that will become current for the next processing iteration through Steps S2 to S4).

The length of the wait in Step S4 will depend on the desired rate for updating the transmission cost parameter. On the one hand, frequent updates (i.e. short or zero wait in Step S4) will provide a more dynamic behaviour that is better able to quickly account for fast changes in traffic loading. On the other hand, too frequent updates may be counter productive in introducing too much additional control signalling into the system. The exact update rate will depend on the application at hand. In a typical implementation an update rate of perhaps once every five or ten minutes might be appropriate. To reduce signalling overhead the processing of FIG. 4 may be modified, for example, Step S3 may only be performed if Step S2 results in a change in the current transmission cost parameter as compared to its previous value. The net result of the processing of FIG. 4 is that MTC entities are made aware of the current cost associated with transmitting data through the e-nodeB.

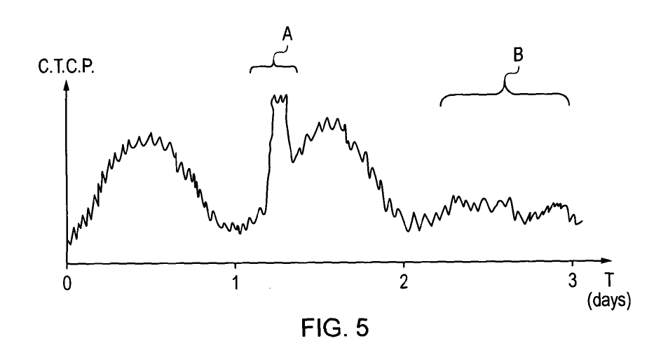

FIG. 5 is a graph schematically showing an example of how an e-nodeB's current transmission cost parameter (CTCP) in arbitrary units might vary over a period of a few days. There can be expected to be a generally diurnal variation, with the cost for MTC transmissions being lower at night compared to during the daytime. This would be associated with the natural increase in H2H communications during daytime. However, in addition to this relatively predictable variation in traffic loading, the dynamic costing approach provided in accordance with embodiments of the present invention is also able to account for unpredictable changes in traffic loading.

For example, in the period identified A in FIG. 5 the e-nodeB establishes a relatively sudden increase in current transmission cost parameter. This might be because a neighbouring e-nodeB has suffered a failure resulting in a sudden increase in H2H communications being routed through the e-nodeB. The current transmission cost parameter is thus increased to discourage MTC entities from using the network during this time. Once the e-nodeB for the neighbouring cell is repaired, the current transmission cost parameter may return to a more typical value for that time of day.

Conversely, the relatively extended period identified B in FIG. 5 is associated with a relatively low transmission cost parameter. This might be because the e-nodeB serves a business district and period B is in a non-working day so there is relatively little H2H traffic. The low transmission cost parameter during this period may thus be used to encourage MTC entities to transmit through the e-nodeB throughout this non-working day.

It is noted that purely for the sake of example, FIG. 5 shows an almost continuum of potential CTCP values. However, in practice there will more likely be a limited number of possible values to adopt. Indeed, in some examples, there may be only two values—a low value and a high value.

FIG. 6 schematically shows processing steps performed by the data transmission controller units 53, 55 in the MTC entities 52, 54 in accordance with an implementation of the present invention. It will be appreciated that the same processing may be performed in any of the MTC entities depending on which one is instigating a data transmission. In this example it will be assumed the processing of FIG. 6 is being performed at the MTC terminal.

Processing starts in Step T1, for example after an initial switch-on/reset of the MTC terminal. The processing steps relating to the implementation of the invention may proceed in parallel with (or interleaved with) the other processing functions of the MTC terminal responsible for governing its general operation.

In Step T2 the MTC terminal determines whether or not it wishes to transmit any data to the MTC server. At any given time this will depend on the normal operating functions of the MTC terminal. For example, in the case of an MTC terminal coupled to a vending machine, a desire to transmit data may arise because the time has come for the MTC terminal to transmit a weekly stock report.

If there is no data to transmit, processing follows the “No” branch to repeat Step T2. This may continue until there is data to be transmitted. In practice the processing might not repeatedly iterate through a step like T2. Instead rather the processing might simply not start until a higher level operating function of the MTC terminal calls the processing routine to start because data has become available for transmission.

If there is data to be transmitted, processing proceeds along the “Yes” branch to Step T3 where the current (i.e. most recently received) transmission cost parameter is retrieved from where it was stored after its receipt from the e-nodeB in Step S3 of FIG. 4.

Processing then follows to Step T4 in which the MTC entity decides if (or how) to transmit the data with the decision being based at least in part on the current transmission cost parameter. In some examples, this decision may be based solely on what the MTC terminal determines will be the cost for transmitting the data at the current time based on the current transmission cost parameter. For example, the MTC terminal might be programmed to only transmit the data if the monetary cost is less than a given threshold. However, in practice more sophisticated algorithms for controlling the transmission of data may be employed. For example, another significant parameter to consider in some implementations will be how important it is to transmit the data. This will depend on the specific implementation and the nature of the data to be transmitted.

For example, if the data is merely an hourly stock up-date for a vending machine, it may be decided that it is not worth transmitting this having regard to the current cost for doing so. Instead the data may be stored with a view to transmitting it later when the cost has reduced. In some cases the data may simply be discarded. For example, an hourly stock update for a vending machine might simply be discarded because there will be another more current update ready to send in the next hour. However, if the data is more important, for example if the data represents the raising of an alarm, such as a tamper alarm, the data transmission controller unit in the MTC terminal may decide to transmit the data immediately regardless of cost. In some situations the perceived importance of transmitting non-time critical data might increase if it continues not to be sent. For example, in a smart meter implementation data representing customer usage for a given period may initially be delayed because of relatively high transmission cost, but might eventually be transmitted regardless of cost as a cut-off for the current billing period approaches.

The exact way in which data transmissions are controlled according to the current cost will most likely vary among different MTC operators according to their individual needs and attitudes to costs. For example one MTC operator, such as a utilities company, might consider reducing transmission costs to be an overriding consideration, whereas another MTC operator, for example vending machine operator, might consider reducing transmission cost to be secondary to maintaining a regular program of data transmission. In summary, each company using MTC entities may be free to in effect write their own algorithms for deciding on whether/how to transmit data according to the applicable transmission cost parameter and any other parameters they consider relevant for properly meeting their needs (for example, importance of data, time since last transmission, amount of data, etc.)

If the result of the Step T4 is a decision to send the data, processing follows the “Yes” branch to Step T5 In Step T5 the data are transmitted from the MTC terminal 52 to the MTC server 54 in accordance with conventional techniques for transmitting data across the radio network 60. Following data transmission in Step T5 the processing returns to Step T2 to wait for the next data for potential transmission to arise.

If, however, the result of the Step T4 is a decision to not send the data, processing follows the “No” branch to Step T6. In Step T6 the processing is paused before returning to repeat Steps T3 and T4 in which the current transmission cost parameter is again retrieved and a decision on transmission made on the basis of the newly retrieved current transmission cost parameter. This cycle may repeat until the data is transmitted. In cases where the data are discarded if they are not transmitted, the processing from Step 14 may instead return directly back to Step T2 to await the next data for potential transmission. In cases where the data are kept for later transmission, the length of the wait in Step 16 may depend, for example, on the expected update rate for the current transmission cost parameter from the e-nodeB 50 and the extent to which delays in the transmission of the data can be tolerated.

FIG. 4 schematically shows processing steps performed by the transmission cost generator unit 51 in the e-nodeB 50 to derive and then communicate the current cost parameter to MTC entities which may want to transmit data through the e-nodeB.

Thus in accordance with embodiments of the invention an MTC operator, that is to say a party that is responsible for deploying and using MTC terminal(s) and server(s), for example, a utilities company or vending machine operator, can program their MTC entities to decide when to communicate MTC data based on current cost, and the radio network operator can dynamically change the cost for transmitting data in response to changing traffic loading.

When data has been transmitted by an MTC entity in the system the billing controller unit 62 establishes an appropriate charging record. One way of doing this is for the billing controller unit 62 to maintain a record of the different current transmission cost parameters associated with the different e-nodeBs in the network for the different times. For example the various current transmission cost parameters for the different e-nodeBs may be communicated to the billing controller unit at the same time as they are communicated to the respective MTC entities. Billing records may then be established in the billing controller unit in a largely conventional manner, except account is taken of the different costs for each transmission depending on the time and the e-nodeB used.

It will be appreciated that while the above description has focussed on some specific example implementations of embodiments of the invention, many variations are possible.

For example, controlling transmission of data in dependence on a current cost established from a costing parameter communicated from the radio network to MTC terminals and/or servers need not be limited to a binary decision on whether or not to transmit data at a given time. Instead the data may be transmitted with selected transmission characteristics that depend on the current transmission cost parameter. For example, in the case of an MTC terminal arranged to transmit video surveillance imagery, it may be considered necessary to maintain transmission regardless of cost, but the terminal may nonetheless be configured to control data transmission based on cost by transmitting lower quality images when transmission costs are high. Higher quality images (comprising more data) may then be transmitted at times when transmission costs are lower. Furthermore, it will be appreciated in some examples the control of data transmission might not be implemented by the MTC entity that is transmitting data, but may be controlled by the MTC entity receiving the data. For example, an MTC terminal might connect to an MTC server to upload data, and the MTC server may then be responsible for deciding if the MTC terminal should be allowed to transfer the data based on the current transmission cost parameter.

Whereas in the above described examples it is the e-nodeBs that are each responsible for generating their own current transmission cost parameter associated with use of their resources, in other implementations the current transmission cost parameter may be established at a different level in the radio network. For example, an element in the backhaul network may provide functionality corresponding to the transmission cost generator unit 51 described above on a network-wide scale. That is to say, a single current transmission cost parameter may be established for the whole network to control overall traffic rather than on an e-nodeB by e-nodeB basis. In other cases different current transmission cost parameters may be established for different geographic regions within the network comprising multiple cells.

In some examples an MTC operator may not wish to make use of the opportunity to reduce costs by controlling transmission. For example, the MTC operator may provide a service that always requires immediate transfer of data, that is to say the data may always be time-critical, such as alarm indications or remote weather reports at an airport. Furthermore, even if a given MTC operator transmits data that is delay tolerant, the MTC operator may simply not want to modify his MTC terminal(s) and/or MTC server(s) to implement an embodiment of the invention. Furthermore still, in some cases an MTC operator may wish to implement an embodiment of the invention in only some of his MTC entities. For example his MTC terminals may incorporate a transmission control scheme in accordance with an embodiment of the invention while his MTC servers might not. In cases where the MTC operator chooses not to implement cost-based transmission control, his data transmission charges may be based on a pre-agreed tariff in the usual way. Alternatively, his data transmissions may be subject to the prevailing variable cost at whatever time the transmissions are made. In the former case the billing control unit in the radio network is provided with a listing of which MTC entities are associated with fixed pricing and generates charging records accordingly. In the latter case, it does not matter to the radio network whether or not the MTC entity's decision to transmit is an informed decision based on the current transmission cost parameter or not.

In some embodiments the mechanism for instigating communication of the current transmission cost parameter from the radio network may be different from the periodic broadcast approach described above. For example, each MTC entity may instead be individually provided with an instantaneous current transmission cost as part of the process for requesting access to the network to transmit data. The MTC entity can then decide whether to proceed with the data transmission or not based on the cost. On the one hand this approach can potentially allow for more finely-tuned data transmission control, but on the other hand, the increased signalling overhead and number of aborted data transmissions may mean a broadcast-type approach for communicating the current transmission cost parameter is more appropriate for many implementations.

It will be appreciated that various modifications can be made to the embodiments described above without departing from the scope of the present invention as defined in the appended claims. In particular although embodiments of the invention have been described with reference to an LTE mobile radio network, it will be appreciated that the present invention can be applied to other forms of network such as GSM, 3G/UMTS, CDMA2000, etc. The term MTC terminal as used herein can be replaced with user equipment (UE), mobile communications device, mobile terminal etc. Furthermore, although the term base station has been used interchangeably with e-nodeB it should be understood that there is no difference in functionality between these network entities.

Thus a method of controlling data transmission over a radio network between a first machine-type communication (MTC) entity and a second MTC entity in a wireless telecommunications system is described. The method comprises an element of the radio network architecture, for example a base station, deriving a transmission cost for transmitting data between the first and second MTC entities based on traffic load, and then communicating the transmission cost to one or both of the MTC entities. The MTC entities may then control their data transmissions based on the transmission cost. Thus the radio network is able to dynamically manage traffic load by providing a cost incentive for transmitting MTC data when network resources are under utilised and applying a cost penalty for transmissions made while the network is relatively busy. Furthermore, the MTC entities of the wireless communication system are able to select times and/or manner of data transmissions to reduce their overall cost of using the network.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] Holma H. and Toskala A, “LTE for UMTS OFDMA and SC-FDMA based radio access”, John Wiley and Sons, 2009.

1. A method for controlling data transmission between a first machine-type communication (MTC) entity and a second MTC entity over a radio network in a wireless telecommunications system, the method comprising:
the radio network determining a transmission cost parameter representing a cost associated with transmitting data between the first and second MTC entities and communicating the transmission parameter to the first MTC entity; and
the first MTC entity controlling data transmission cost between the first and second MTC entities in dependence on the transmission cost parameter.

2. The method of claim 1, wherein the transmission cost parameter is determined in dependence on a level of traffic in the radio network.

3. The method of claim 1, wherein the step of the first MTC entity controlling data transmission comprises the MTC entity determining whether or not to transmit data in dependence on the transmission cost parameter.

4. The method of claim 3, wherein in the event the first MTC entity does not transmit the data, the method further comprises storing the data for transmission at a later time.

5. The method of claim 1, wherein the step of the first MTC entity controlling data transmission comprises the first MTC entity selecting transmission characteristics for the data transmission.

6. The method of claim 1, wherein the step of determining the transmission cost parameter is performed in a transceiver station of the radio network such that the transmission cost parameter is specific to data transmissions associated with the transceiver station.

7. The method of claim 1, further comprising communicating the transmission cost parameter to a billing controller unit of the radio network.

8. The method of claim 1, wherein the step of the first MTC entity controlling data transmission is further dependent on a transmission priority level for data for potential transmission.

9. The method of claim 8, wherein the transmission priority level for data is dependent on the extent to which transmission of the data has previously been delayed.

10. The method of claim 1, wherein the transmission cost parameter is associated with data transmission using a first transmission path in the radio network and the method further comprises the radio network determining another transmission cost parameters associated with data transmissions using different transmission paths together and communicating the collated transmission cost parameters together to the first MTC entity.

11. The method of claim 10, wherein the step of communicating the transmission cost parameter to the first MTC entity comprises collating the transmission cost parameters associated with data transmissions using different transmission paths together and communicating the collated transmission cost parameters together to the first MTC entity.

12. The method of claim 10, further comprising a step of establishing which transmission path would be used in transmitting data to the second MTC entity and communicating the corresponding transmission cost to the first MTC entity with an indication it is associated with data transmission to the second MTC entity.

13. A method of controlling data transmission associated with a machine-type communication (MTC) entity over a radio network in a wireless telecommunications system, the method comprising:
the radio network determining a transmission cost parameter representing a cost associated with transmitting data in the radio network and communicating the transmission cost parameter to the MTC entity; and
the MTC entity controlling data transmission associated with the MTC entity in dependence on the transmission cost parameter.

14. A wireless transmission system comprising a radio network and first and second machine-type communication (MTC) entities arranged to communicate data between themselves over the radio network; wherein
the radio network comprises a transmission cost generator unit and a transmission cost communication unit, wherein the transmission cost generator unit is operable to determine a transmission cost parameter representing a cost associated with transmitting data over the radio network and the transmission cost communication unit is operable to communicate the transmission cost parameter from the radio network to the first MTC entity; and
the first MTC entity comprises a data transmission controller unit operable to control data transmission between the first and second MTC entities in dependence on the transmission cost parameter.

15. The wireless telecommunications system of claim 14, wherein the transmission cost generator unit is operable to determine the transmission cost parameter in dependence on a level of traffic in the radio network.

16. The wireless telecommunications systems of claim 14, wherein the data transmission controller unit is operable to control data transmission by determining whether or not transmit data in dependence on the transmission cost parameter.

17. The wireless telecommunications system of claim 16, wherein the first MTC entity comprises a memory for storing data which the data transmission controller unit has determined not to transmit for potential transmission at a later time.

18. The wireless telecommunications system of claim 14, wherein the data transmission controller unit is operable to control data transmission by selecting data transmission characteristics in dependence on the transmission cost parameter.

19. The wireless telecommunications system of claim 14, wherein the transmission cost generator unit is in a transceiver station of the radio network and the transmission cost parameter is associated with data transmission through that transceiver station.

20. The wireless telecommunications system of claim 14, wherein the transmission cost communication unit is further operable to communicate the transmission cost parameter to a billing controller unit of the radio network.

21. The wireless telecommunications system of claim 14, wherein the data transmission controller unit is further operable to control data transmission in dependence on a transmission priority level for the data.

22. The wireless telecommunications system of claim 21, wherein the transmission priority level for the data is dependent on the extent to which transmission of the data has previously been delayed.

23. The wireless telecommunications system of claim 14, wherein the transmission cost parameter is associated with data transmission using a first transmission path in the radio network and the transmission cost generator unit is further operable to determine another transmission cost parameter representing a cost associated with transmitting data using a second transmission path which is different from the first transmission path.

24. The wireless telecommunications system of claim 23, wherein the transmission cost communication unit is operable to collate transmission cost parameters associated with data transmissions using different transmission paths together and communicate the collated transmission cost parameters together to the first MTC entity.

25. The wireless telecommunications system of claim 23, wherein the transmission cost generator unit is operable to establish which transmission path would be used in transmitting data to the second MTC entity and the transmission cost communication unit is operable to communicate the corresponding transmission cost to the first MTC entity with an indication that it is associated with data transmission to the second MTC entity.

26. A wireless telecommunications system comprising a radio network and a machine-type communication (MTC) entity arranged to communicate data over the radio network;
wherein the radio network comprises a transmission cost generator unit and a transmission cost communication unit, wherein the transmission cost generator unit is operable to determine a transmission cost parameter representing a cost associated with transmitting data over the radio network and the transmission cost communication unit is operable to communicate the transmission cost parameter from the radio network to the MTC entity; and
the MTC entity comprises a data transmission controller unit operable to control data transmission associated with the MTC entity in dependence on the transmission cost parameter.

27. A wireless telecommunications system comprising a radio network and first and second machine-type communication (MTC) entities arranged to communicate data between themselves over the radio network; wherein
the radio network comprises means for determining a transmission cost parameter representing a cost associated with transmitting data over the radio network and, means for communicating the transmission cost parameter from the radio network to the MTC entity; and
the first MTC entity comprises means for controlling data transmission between the first and second MTC entities in dependence on the transmission cost parameter.
